(19) United States
(12) Patent Application Publication
(10) Pub. No.: US 2011/0272914 A1
(43) Pub. Date: Nov. 10, 2011

(54) WHEELCHAIR ATTACHMENT DEVICE

(76) Inventor: MIKE GORMLEY, Russellville, KY (US)

(21) Appl. No.: 12/773,215

(22) Filed: May 4, 2010

(51) Int. Cl. A61G 5/10

(52) U.S. Cl. 280/304.1

(57) ABSTRACT

A wheelchair attachment device comprising an elongated body with a plurality of holes, a base bar attached at a lower portion of the elongated body, a mounting bracket to attach the base bar to the plurality of holes along the elongated body, an attachment screw to affix the base bar to a wheelchair, a top bar at an upper portion of the elongated body, a set of butterfly nuts to attach the elongated body to the top bar, a strap wherein the strap secures a bow to the top bar to allow a user to shoot the bow while seated in the wheelchair. The wheelchair attachment device may be raised or lowered depending on the user and the direction of their shot. Various recreational apparatus may be secured on the wheelchair attachment device, including a hand gun, rifle or even a video camera.

### BACKGROUND OF THE INVENTION

1. Field of Invention

The present invention relates to an attachment device for wheelchairs, which may allow a user to manipulate a recreational apparatus, such as a bow, while seated in a wheelchair.

2. Description of Related Art

For centuries, archery has been a means of hunting and survival for various groups of people around the world. Today, archery is not only used as a way to hunt food, but also as a sport even recognized at the Olympic Games. Gone are the simple bows and arrows from generations past. The latest bows are equipped with pulley systems, locking mechanisms and advanced scopes to attain the perfect shot. As the technology in archery advances, one thing remains the same, the desire shared by kids and adults to learn the skill and precision to become a master archer.

Some individuals with limited movement and who may be confined to a wheelchair may find archery a frustrating or even impossible activity. Since shooting a bow and arrow requires the use of both arms, these individuals are left out of this enjoyable pastime. It would be beneficial in the art to create a device which could aid a person with limited motion to use a two-handed piece of recreational equipment. It would be desirable for the device to attach to the person's wheelchair so that their mobility is not limited to a stationary point for use.

### SUMMARY OF THE INVENTION

The purpose of the present invention is to provide a wheelchair accessory which may allow individuals with physical limitations to enjoy the sport of archery. The wheelchair attachment device may attach at a lower portion to a body of a wheelchair while supporting a bow at a top portion. The bow may be held in place while the user moves their mobile hand to engage an arrow and string to make a shot. The wheelchair attachment device may raise or lower depending on the height of the user, and it may turn depending on the direction for shooting. A bow is not the only instrument which may be used. A hand gun, rifle, video camera or other recreational apparatus may be held against the wheelchair attachment device in a similar fashion as the bow.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 is a perspective view of a wheelchair attachment device in accordance with an exemplary embodiment of the present invention.

### DETAILED DESCRIPTION OF THE DRAWINGS

The present invention discloses a wheelchair attachment device, which may be affixed to a wheelchair to allow a bow to be manipulated by a user thereof. The wheelchair attachment device may hold the bow in place on the wheelchair while the user moves a single hand and arm to make a shot. The wheelchair attachment device may be adjusted on the wheelchair so that the aim with the bow is multidirectional. Also, since the wheelchair attachment device may raise and lower in height, both children and adults may find the device entertaining and useful. Finally, the wheelchair attachment device may be used to attach other items such as a hand gun, rifle, video camera or other recreational apparatus.

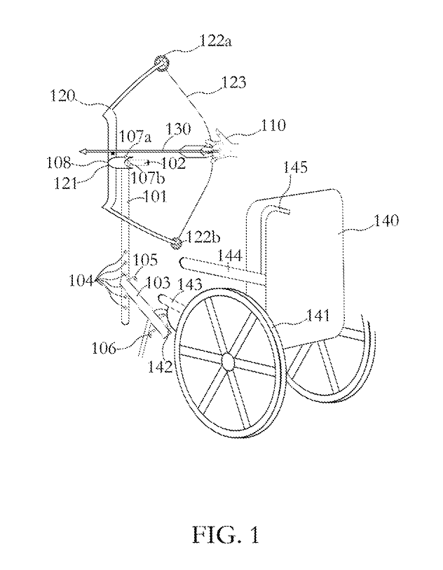

Turning descriptively to the drawings, FIG. 1 is a perspective view of a wheelchair attachment device in accordance with an exemplary embodiment of the present invention. The wheelchair attachment device may include an elongated body (101), a top bar (102) and a base bar (103). The elongated body (101) may have a plurality of adjustment holes (104) (hereinafter holes) at a lower portion. The base bar (103) may have a mounting bracket (105) to adjoin the base bar (103) to the elongated body (101) through the holes. The holes (104) may allow the wheelchair attachment device to be raised or lowered depending on a user. The mounting bracket (105) may permit the elongated body (101) to turn at a point there the elongated body (101) meets the base bar (103). The mounting bracket (105) may be attached with a screw, a bolt, a butterfly nut, a pin or any other device commonly known or used in the art. The present invention may be coupled with a wheelchair to allow a user greater stability to engage in various activities. The wheelchair may comprise a wheel (141), a body portion (142), a seat (143), an arm rest (144) and a handle (145). The body portion (142) may attach to the base bar (103) by an attachment screw (106).

The top bar (102) may be positioned on a top portion of the elongated body (101) with a set of butterfly nuts (107a, 107b). The top bar (102) may rest against a handle (121) of a bow (120). A flexible strap (108) may loop around the set of butterfly nuts (107a, 107b) to secure the bow (120) to the top bar (102). The flexible strap (108) may be a rubber strap, an elastic band, a portion of string or any device which may easily be used to attach the bow (120) and the top bar (102). A hand gun, a rifle, a video camera or various other recreational apparatus may also be attached to the wheelchair attachment device in a similar fashion as the bow (120).

The wheelchair attachment device may be used when a user engages a dominant hand (110) to pull an arrow (130) set against a string (123) on the bow (120). The string (123) may attach to the bow (120) over a set of wheels (122a, 122b). As the arrow (130) is pulled, the bow may bend more to create a tension between the bow (120) and the string (123). The further the arrow (130) is pulled the greater amount of tension created. Finally, the user may release the arrow (130) with their dominant hand (110), and the tension causes the arrow (130) to fly towards a target. The wheelchair attachment device may allow individuals who are not normally able to shoot a bow and arrow to participate and enjoy the sport of archery. The present invention may not be limited to a bow but also to other devices like a hand gun, a rifle or even a video camera. The wheelchair attachment device may open a wide range of new activities and sports for those who may be physically limited in a wheelchair yet not mentally limited in their desire for fun and adventure.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A wheelchair attachment device comprising:
an elongated body with a plurality of holes;
a base bar attached at a lower portion of the elongated body;
a mounting bracket to attach the base bar to the plurality of holes along the elongated body;
an attachment screw to affix the base bar to a wheelchair;
a top bar at an upper portion of the elongated body;
a set of butterfly nuts to attach the elongated body to the top bar; and
a strap wherein the strap secures a recreational apparatus to the top bar to allow a user to use the recreational apparatus while seated in the wheelchair.

2. The wheelchair attachment device of claim 1, wherein the recreational apparatus includes at least one of a bow, a hand gun, a rifle and a video camera.

3. The wheelchair attachment device of claim 1, wherein the plurality of holes along the elongated body allow for the vertical adjustment of the wheelchair attachment device.

4. The wheelchair attachment device of claim 1, wherein the flexible strap includes at least one of a rubber strap, elastic band and a portion of string.

5. The wheelchair attachment device of claim 1, wherein the mounting bracket allows the elongated body to turn at a point where the elongated body meets the base bar.
